(19) United States
(12) Patent Application Publication
(10) Pub. No.: US 2008/0208390 A1
(43) Pub. Date: Aug. 28, 2008

(54) SORTING PARCELS WITH IMPLICIT IDENTIFICATION

(76) Inventor: Alfred T Rundle, Endwell, NY (US)

Correspondence Address: MILES & STOCKBRIDGE PC, 1751 PINNACLE DRIVE, SUITE 500, MCLEAN, VA, 22102-3833, US

(21) Appl. No.: 11/680,381

(22) Filed: Feb. 28, 2007

(51) Int. Cl. B07C 5/00

(52) U.S. Cl. 700/225; 209/584

(57) ABSTRACT

A method for sorting parcels may include reading, during a first sortation pass, machine readable indicia applied to the parcel prior to mailing and at least a portion of delivery address information on a parcel. The method may also include selecting a reference indicium from the machine readable indicia and creating an entry, corresponding to the reference indicia, in a first database, the entry including a portion of the delivery address information for the parcel and a value corresponding to the reference indicium. The method may include forwarding the entry to a second database different from the first database, the second database corresponding to the delivery address information. The method may include reading the machine readable indicia during a second sortation pass, subsequent to the first, identifying the reference indicium and retrieving the entry corresponding to the reference indicium from the second database, and sorting the parcel according to the portion of the delivery address information in the entry retrieved from the database.

The present invention relates generally to sorting and, more particularly, to computerized parcel sorting.

Applying an identification tag to a mail piece may allow optical character recognition (OCR) results and video coding system (VCS) results, for example a destination ZIP code determination, to be associated with the mail piece and stored in a database. The identification tag may be a barcode, or other machine readable indicia, that is applied directly to the mail piece, or applied to an adhesive backed label that is then affixed to the mailpiece. Once the mail piece has an identification tag applied, the need to repeat the OCR or VCS process during a subsequent sortation may be reduced because the identification tag may be read and the previously stored OCR or VCS results may be retrieved from the database. While the practice of applying identification tags to flat mail pieces may be relatively easy due to the typically predictable and somewhat limited range of dimensions of flat mail pieces, applying identification tags to parcels may present a difficulty due to variation in size or shape of parcels being mailed.

Various methods and systems have been developed to provide alternatives to applying identification tags to mail pieces. For example, some conventional systems have used an aspect of the mail piece in combination with a particular position in a sorting machine, or a particular sorting tray location, to identify the mail piece. These systems may suffer from a limitation of having to maintain a certain order during sortation passes, or maintaining the mail piece in a particular coded sorting tray. Other conventional systems rely on an identifier based on a signature extracted from an image of a surface of a mail piece, including an address block and a physical characteristic of the image. Because of potential inaccuracies in extracting address block information or physical characteristic information, the above-mentioned conventional system may suffer from a limitation of having to use a possibly imprecise signature to attempt to identify the mail piece.

The present invention was conceived in light of the above-mentioned difficulty with parcel identification tagging and a desire to achieve a sorting efficiency similar to that achieved using identification tags, but without the expense and operational requirements that may accompany an identification tagging system.

In one aspect, an exemplary embodiment of the present invention relates to a method for sorting parcels may include reading, during a first sortation pass, machine readable indicia applied to the parcel prior to mailing and at least a portion of delivery address information on a parcel. The method may also include selecting a reference indicium from the machine readable indicia and creating an entry, corresponding to the reference indicia, in a first database, the entry including a portion of the delivery address information for the parcel and a value corresponding to the reference indicium. The method may include forwarding the entry to a second database different from the first database, the second database corresponding to the delivery address information. The method may include reading the machine readable indicia during a second sortation pass, subsequent to the first, identifying the reference indicium and retrieving the entry corresponding to the reference indicium from the second database, and sorting the parcel according to the portion of the delivery address information in the entry retrieved from the database.

In another aspect, an exemplary embodiment of the present invention relates to a computer system for sorting parcels, the computer system including a processor, and a memory including software instructions that, when executed, cause the computer system to perform a series of steps. The steps may include reading, during a first sortation pass, at least one machine readable indicia and delivery address information on a parcel, the at least one machine readable indicia having been applied to the parcel prior to mailing, and selecting a reference indicium from the at least one machine readable indicia. The steps may also include creating an entry, corresponding to the reference indicia, in a database, the entry including a portion of the delivery address information for the parcel and a value corresponding to the reference indicium. The steps may include reading the at least one machine readable indicia during a second sortation pass, subsequent to the first, identifying the reference indicium and retrieving the entry corresponding to the reference indicium from the database, and sorting the parcel according to the portion of the delivery address information in the entry retrieved from the database.

In another aspect, an exemplary embodiment of the present invention relates to a computer program product for sorting parcels. The computer program product may include software instructions for enabling a computer to perform predetermined operations, and a computer readable medium bearing the software instructions. The predetermined operations may include reading, during a first sortation pass, machine readable indicia and delivery address information on a parcel, the machine readable indicia having been applied to the parcel prior to mailing, and selecting a reference indicium from the machine readable indicia. The operations may also include creating an entry, corresponding to the reference indicia, in a database, the entry including a portion of the delivery address information for the parcel and a value corresponding to the reference indicium. The operations may also include reading the machine readable indicia during a second sortation pass, subsequent to the first, identifying the reference indicium and retrieving the entry corresponding to the reference indicium from the database, and sorting the parcel according to the portion of the delivery address information in the entry retrieved from the database.

### BRIEF DESCRIPTION OF THE DRAWINGS

FIG. 1 provides a block diagram illustration of an exemplary mail sorting system;

FIG. 2 provides a flowchart illustrating an exemplary embodiment of a method of sorting parcels with implicit identification in accordance with the present invention;

FIG. 3 provides a diagrammatic illustration of an exemplary image of a parcel surface;

FIG. 4 provides a flowchart illustrating an exemplary embodiment of a method of sorting parcels during a first sortation pass with implicit identification in accordance with the present invention;

FIG. 5 provides a flowchart illustrating an exemplary embodiment of a method of sorting parcels during a subsequent sortation pass with implicit identification in accordance with the present invention; and

FIG. 6 provides a flowchart illustrating an exemplary embodiment of a method of sorting parcels during a subsequent sortation pass with implicit identification in accordance with the present invention.

### DETAILED DESCRIPTION

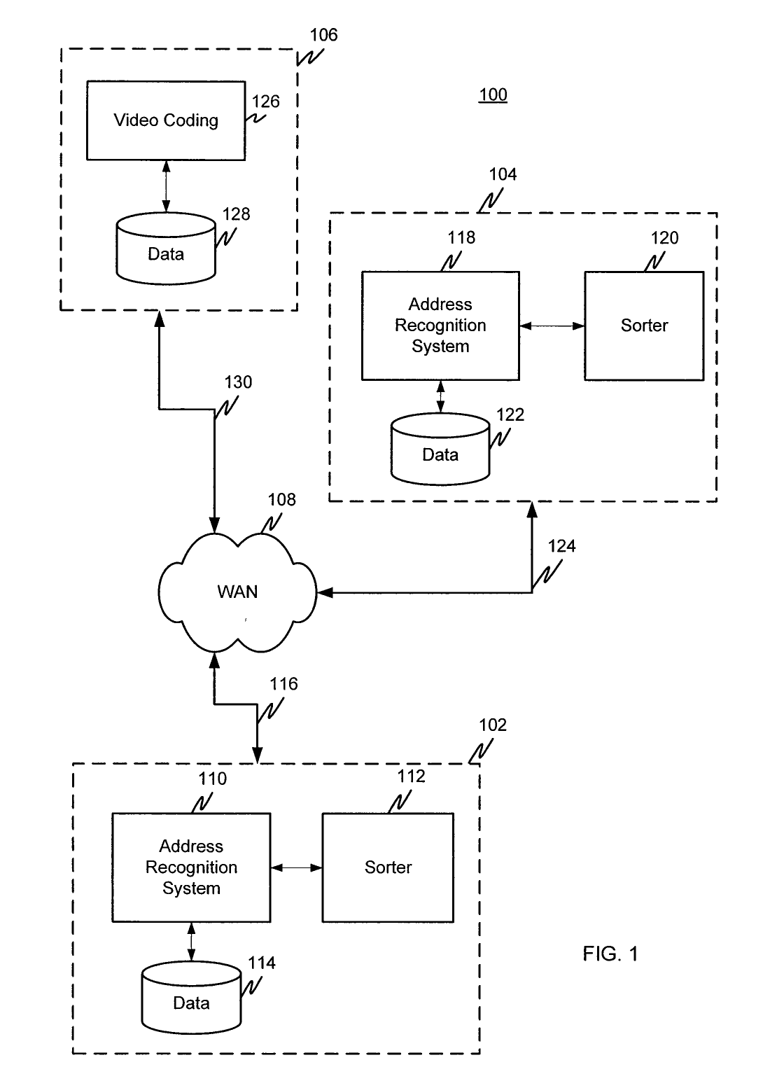

FIG. 1 provides a block diagram illustration of an exemplary mail sorting system. In particular, a mail sorting system 100 includes a first mail sorting station 102, a second mail sorting station 104, and a video coding system 106, each of which is connected to a wide area network (WAN) 108. The first mail sorting station 102 includes an address recognition system 110, a sorter 112, a database 114, and a first link 116. The second mail sorting station 104 includes an address recognition system 118, a sorter 120, a database 122, and a second link 124. The video coding system 106 includes one or more video coding stations 126, a database 128, and a third link 130.

The first mail sorting station may be coupled to the WAN 108 via the first link 116. In operation, parcels may be placed on the sorter 112. The address recognition system 110 may take an image of the parcel and process the image using OCR techniques in order to obtain destination address information. If the address recognition system 110 is able to automatically determine destination address information for the parcel, then the sorter 112 may be directed to sort the parcel according to the destination address information. The destination address information may be stored in database 114 and forwarded to a database at a destination sorting station. For example, the sorter 112 may sort the parcel into a bin for delivery to the second mail sorting station 104 and the first sorting station 102 may forward the stored destination address information from database 114 to the second sorting station 106 for storage in its database 122. If the address recognition system 110 is unable to automatically obtain destination address information, the image of the parcel may be transmitted to the video coding system 106 via the WAN 108.

At the video coding system 106, the image of the parcel may be sent to one or more video coding stations 126 for video coding by one or more operators. Once the video coding process is complete, the results as may be stored in the video coding database 128, including destination address information may be returned to the first mail sorting station 102, stored in the database 114, and the sorter 112 may be directed to sort the parcel according to the destination address information and the first mail sorting station 102 may forward the stored destination address information to a destination mail sorting station.

Having either automatically determined destination address information through OCR or having manually determined it through video coding, it is desirable to retain and store the destination address information for use in the future, for example, when the parcel reaches the second mail sorting station 104. In order to associate the stored address information with the parcel a method of identifying the parcel may be useful.

In one aspect, the present invention provides a method and system for sorting parcels with implicit identification. The term “implicit identification” as used herein refers generally to any computer readable element already present on or in a parcel prior to mailing or sorting. In other words, embodiments of the present invention may identify a parcel and track it through various sorting processes by adopting machine readable indicia or elements already placed on or in the parcel for other purposes and using one or more of the indicia or elements as an identification tag for sorting purposes. Thus, a need to affix or apply an additional machine readable identification label or tag after the parcel has been received for sorting may be reduced.

At the second mail sorting station 104, the parcel may be received and placed on the sorter 120. The address recognition system 118 may take an image of the parcel. If the address recognition system 118 is able to identify the parcel, then it may access the database 122 in order to retrieve any available stored destination address information for the parcel, thus possibly reducing the need for an additional OCR or video coding step. An exemplary embodiment of the method of tracking and identifying parcels in accordance with the present invention is described below.

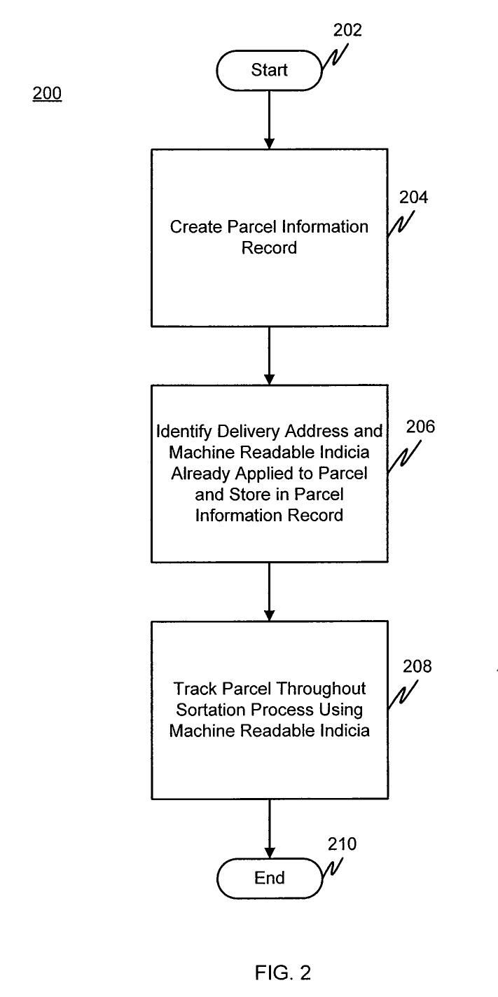

FIG. 2 provides a flowchart 200 illustrating an exemplary embodiment of a method for sorting parcels with implicit identification in accordance with the present invention. In particular, the method begins at step 202 and continues to step 204.

In step 204, a new parcel information record is created for a new parcel being sorted. The parcel information record may include, for example, a field for an identification value, destination address fields, return address fields, postage fields, physical dimension fields, and the like. The parcel information record may be empty initially, pending the reading of information from the parcel. Once the new parcel information record has been created control continues to step 206.

In step 206, delivery address information and machine readable indicia information are identified on the parcel and read by the address recognition system. A portion of the delivery address and the machine readable indicia information are stored in the parcel information record created in step 204. Control continues to step 208.

In step 208, the parcel is tracked throughout sortation using the machine readable indicia. This includes reading the machine readable indicia at each sortation and looking up a value corresponding to the machine readable indicia in a database containing parcel identification records and retrieving the parcel identification record associated with the parcel being sorted. The method continues to step 210, where the method ends. It should be appreciated that steps 204-208 may be repeated in order to sort an incoming stream of parcels. Further, steps 204-208 may be performed on the same or different equipment in the same or different facilities.

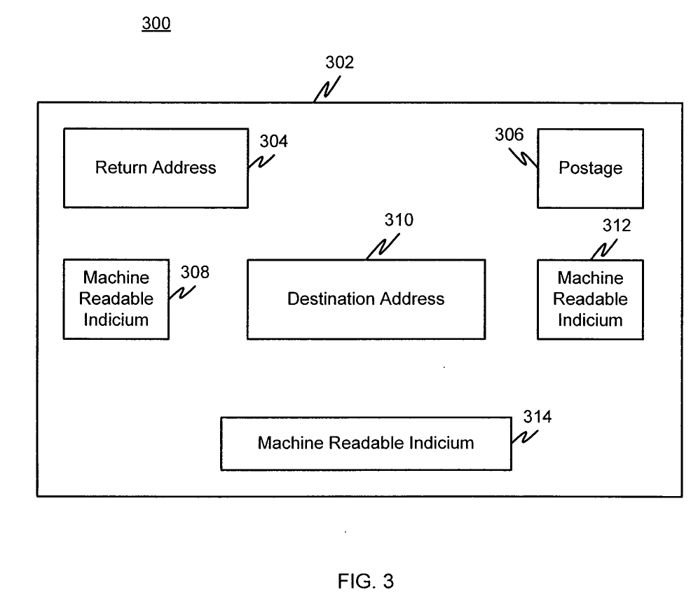

FIG. 3 provides a diagrammatic illustration of an exemplary image of a parcel surface. In particular, an exemplary parcel image 300 includes a parcel surface 302, a return address block 304, a postage block 306, a first machine readable indicium 308, a destination address block 310, a second machine readable indicium 312, and a third machine readable indicium 314.

In a sorting operation, an address recognition system may take an image of the mail piece as represented in FIG. 3. The address recognition system may attempt to recognize the handwritten or machine printed return address 304 and destination address 310. The address recognition system may also attempt to validate the postage 306.

Various machine readable indicia may be applied to a parcel prior to mailing. The address recognition system may attempt to read and interpret any machine readable indicia (such as 308, 312, and 314) that may be present on the parcel. These indicia may include, for example, a USPS delivery confirmation barcode, a US or international customs barcode, a USPS POSTNET barcode, a USPS PLANET barcode, USPS 4-state barcode, postage barcode, shipper barcode, or the like. These barcodes may be printed on a label that is then affixed to the parcel, may be printed directly on the parcel, or may be applied in any suitable manner for such indicia.

Some barcodes may be of a standard format such that the address recognition system can identify them as unique codes. For example, delivery confirmation and customs barcodes are typically unique identifiers. Other barcodes may not be unique, such as POSTNET, PLANET, or shipper barcodes.

In the case where one or more unique barcodes are present on the parcel, the methods and systems of the present invention may use that barcode value as a unique parcel identifier for future sorting. In the case where no single barcode, or other machine readable element, represent a unique value in the database, embodiments of the method and system of the present invention may use a combination of two or more non-unique values to obtain a unique value for identifying the parcel. For example, machine readable indicia 312 and 314 may not, in themselves, be unique, but a combination of the two may yield a unique identifier for use in the database.

Also, a non-unique value associated with machine readable indicia may be used. If a non-unique value is used, then additional steps may be performed at a subsequent sorting in order to resolve any ambiguity. Various embodiments of the method and system of the present invention in relation to different sorting stages are described below.

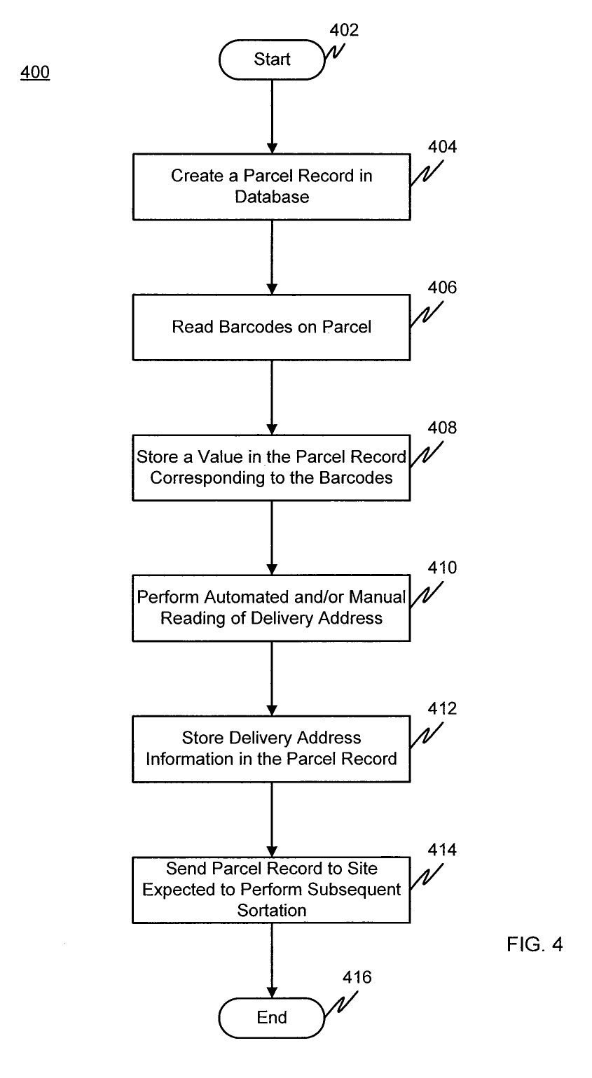

FIG. 4 provides a flowchart 400 illustrating an exemplary embodiment of a method of sorting parcels during a first sortation pass with implicit identification in accordance with the present invention. The method begins at step 402 and continues to step 404.

In step 404, a parcel record is created in a database. This parcel record may represent an incoming parcel ready for sortation. The parcel record may include destination address fields, parcel identification fields, and other fields related to sorting or delivering the parcel. The method continues to step 406.

In step 406, barcodes, or other machine readable elements, present on the parcel prior to mailing are read. The system may then attempt to identify a unique value from among the various barcodes read to be used as a reference indicium for the parcel. As mentioned above, some barcodes are standard and known to be unique, while others may be non-unique. The system may then arrive at a unique or non-unique value, corresponding to the reference indicium, for identifying the parcel. The method continues to step 408, where the value corresponding to one or more of the barcodes is stored in the parcel record for use in later identifying the parcel. The method continues to step 410.

In step 410, delivery, or destination, address information is read, either manually or automatically, from the parcel image. It should be appreciated that other information about the parcel may be read and that the order of reading addresses, machine readable indicia, or other information from the parcel image may be varied. After obtaining some or all of the destination address information, the method continues to step 412 where at least a portion of the destination address information is stored in the parcel record. The method continues to step 414.

In step 414, the parcel record is sent to a site expected to perform a subsequent sorting on the parcel. Also, the parcel may be sorted into a bin or the like for shipment to the site expected to perform a subsequent sorting on the parcel. It should be appreciated that the site performing the subsequent sorting may be the same site as performs the first sorting pass on the parcel. Thus, both the parcel and the parcel record may remain in the same location for a subsequent sorting pass, or one or both may be sent to a different location for use in a subsequent sorting pass. The method continues to step 416, where the method ends. It should be appreciated that steps 402-416 may be repeated, fully or in part, as necessary or desired to accomplish a contemplated parcel sorting task.

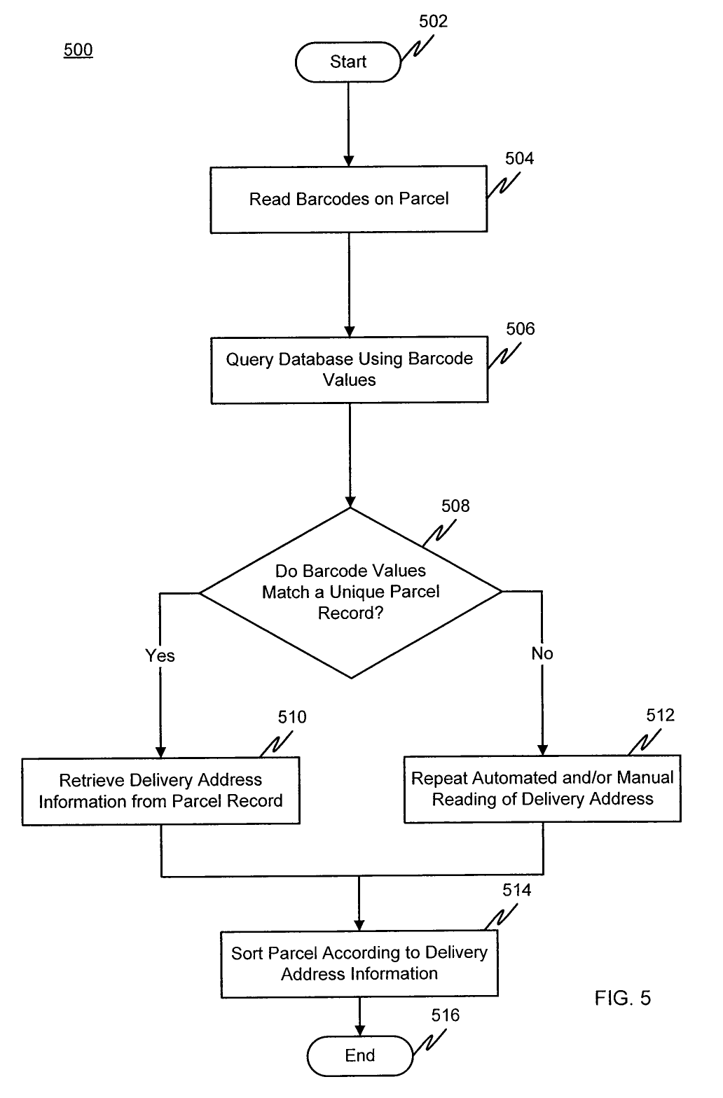

FIG. 5 provides a flowchart illustrating an exemplary embodiment of operating a sorting system according to a method of sorting parcels during a subsequent sortation pass with implicit identification for in accordance with the present invention. In particular, the method begins at step 502 and continues to step 504.

In step 504, some or all of the barcodes, or other machine readable elements, present on the parcel prior to mailing are read. The method continues to step 506.

In step 506, a database is queried using some or all of the barcode value read in step 504. The method continues to step 508, where results of the database query are evaluated. In step 508, if a barcode value matches a unique database parcel record, then the method continues to step 510. If none of the barcode values, or combinations of values, matches a unique database entry, then the method continues to step 512.

In step 510, the parcel record matching the barcode value is retrieved along with the delivery, or destination, address information. The method continues to step 514.

In step 512, a repeat of an automated (e.g., OCR) or manual (e.g., video coding) process may be performed in order to obtain the delivery, or destination, address information. The method then continues to step 514.

In step 514, the destination address information obtained in steps 510 or 512 is used to sort the parcel. The method continues to step 516, where the method ends. It should be appreciate that steps 502-516 may be repeated, fully or in part, as necessary or desired in order to accomplish a contemplated sorting operation.

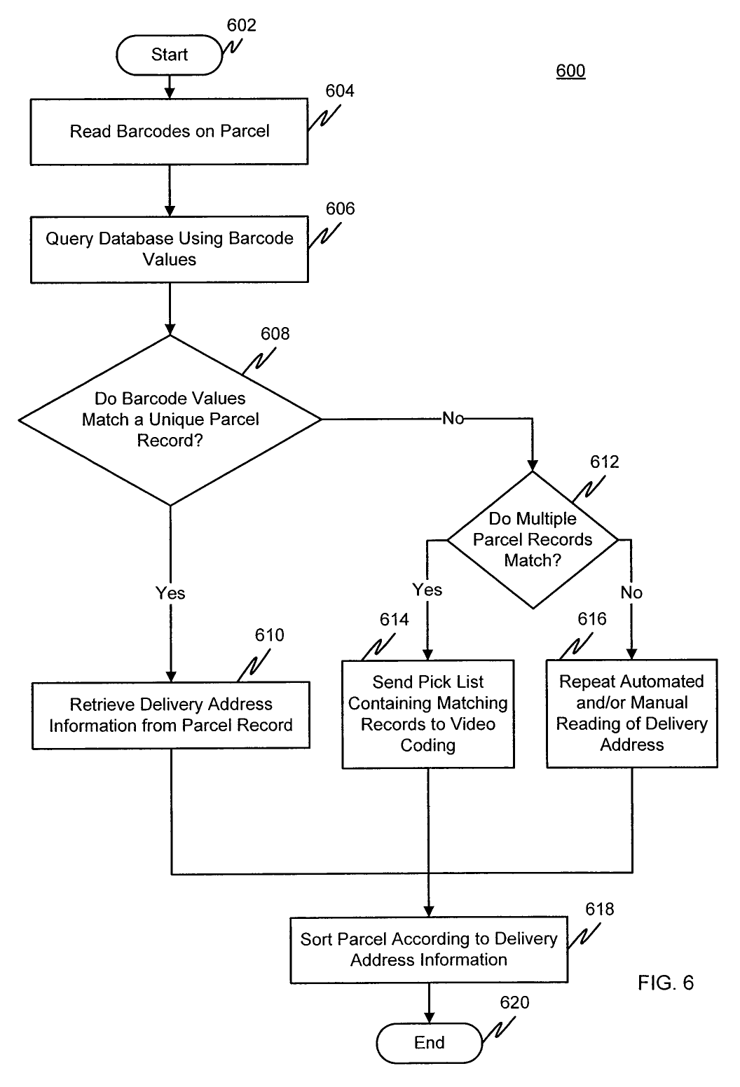

FIG. 6 provides a flowchart 600 illustrating an exemplary embodiment of operating a parcel sorting system according to a method of sorting parcels during a subsequent sortation pass with implicit identification in accordance with the present invention. In particular, the method begins at step 602 and continues to step 604.

In step 604, some or all of the barcodes, or other machine readable elements, present on the parcel prior to mailing are read. The method continues to step 606.

In step 606, a database is queried using some or all of the barcode value read in step 604. The method continues to step 608, where results of the database query are evaluated. In step 608, if a barcode value matches a unique database parcel record, then the method continues to step 610. If none of the barcode values, or combinations of barcode values, matches a unique database entry, then the method continues to step 612.

In step 610, the parcel record matching the barcode value is retrieved along with the delivery, or destination, address information. The method continues to step 618.

In step 612, results of the database query are evaluated further. If database query returned multiple parcel records matching barcode values from the parcel, the method continues to step 614. If the database query returned no parcel records then the method continues to step 616.

In step 614, a “pick list” containing the multiple matching records may be sent to video coding for a manually selection of the correct parcel record. The method continues to step 618.

In step 616, a repeat of an automated (e.g., OCR) or manual (e.g., video coding) process may be performed in order to obtain the delivery, or destination, address information. The method then continues to step 618.

In step 618, using the delivery, or destination, address information obtained in steps 610, 614, or 616, the parcel is sorted. The method continues to step 620, where the method ends. It should be appreciate that steps 602-620 may be repeated, fully or in part, as necessary or desired in order to accomplish a contemplated sorting operation.

It should also be appreciated that the above exemplary embodiments include only two sorting passes for simplicity of illustration. More or less sorting passes may be used in a contemplated sorting operation. Also, some details associated with sorting equipment and procedure not directly related to describing the present invention may have been simplified or not discussed in order to provide a more clear description of embodiments of the present invention.

While exemplary embodiments of the method, system, and computer program product for sorting parcels with implicit identification of the present invention have been described above in relation to barcodes for illustration purposes, it should be appreciated that machine readable indicia may include other machine readable elements, such as, for example, radio frequency identification tags (RFID), image based tags, chemical based tags, biological tags, or other identification or encoding elements that are presently, or in the future may become, machine readable. In general, any machine readable identification element affixed to, within, or applied to a parcel may be used in connection with the method, system, and computer program product for sorting parcels with implicit identification according to the present invention.

The method, system, and computer program product for sorting parcels with implicit identification, exemplary embodiments of which are described above and shown in the figures, may be implemented on a general-purpose computer, a special-purpose computer, a programmed microprocessor or microcontroller and peripheral integrated circuit element, and ASIC or other integrated circuit, a digital signal processor, a hardwired electronic or logic circuit such as a discrete element circuit, a programmed logic device such as a PLD, PLA, FPGA, PAL, or the like. In general, any process capable of implementing the functions or steps described herein may be used to implement the method, system, or computer program product for sorting parcels with implicit identification according to this invention.

Furthermore, the disclosed method, system, and computer program product for sorting parcels with implicit identification may be readily implemented, fully or partially, in software using, for example, object or object-oriented software development environments that provide portable source code that can be used on a variety of computer platforms. Alternatively, the disclosed method, system, and computer program product for sorting parcels with implicit identification may be implemented partially or fully in hardware using, for example, standard logic circuits or a VLSI design. Other hardware or software can be used to implement the systems in accordance with this invention depending on the speed and/or efficiency requirements of the systems, the particular function, and/or a particular software or hardware system, microprocessor, or microcomputer system being utilized. The method, system, and computer program product for sorting parcels with implicit identification illustrated herein can readily be implemented in hardware and/or software using any known or later developed systems or structures, devices and/or software by those of ordinary skill in the applicable art from the functional description provided herein and with a general basic knowledge of the computer, network communication, and optical recognition arts.

Moreover, the disclosed method, system, and computer program product for sorting parcels with implicit identification may be readily implemented in software executed on programmed general-purpose computer, a special purpose computer, a microprocessor, or the like. In these instances, the sorting method of this invention can be implemented as a program embedded on a personal computer such as a JAVA® or CGI script, as a resource residing on a server or graphics workstation, as a routine embedded in a dedicated encoding/decoding system, or the like. The method and system can also be implemented by physically incorporating the method for sorting parcels with implicit identification into a software and/or hardware system, such as the hardware and software systems of parcel sorting equipment.

It is, therefore, apparent that there is provided in accordance with the present invention, a method, system, and computer program product for sorting parcels with implicit identification. While this invention has been described in conjunction with a number of embodiments, it is evident that many alternatives, modifications and variations would be or are apparent to those of ordinary skill in the applicable arts. Accordingly, applicants intend to embrace all such alternatives, modifications, equivalents and variations that are within the spirit and scope of this invention.

What is claimed is:

1. A method for sorting parcels, the method comprising:
reading, during a first sortation pass, all machine readable indicia and at least a portion of delivery address information on a parcel, the machine readable indicia having been applied to the parcel prior to mailing;
determining if any combination of the machine readable indicia applied to the parcel is unique in a first database and selecting a unique machine readable indicia combination, if present, as a reference indicia, the reference indicia including a combination of discrete machine readable indicia, and if no combination of machine readable indicia is unique in the first database, then selecting a non-unique combination of machine readable indicia as the reference indicia;
creating an entry, corresponding to the reference indicia, in the first database, the entry including a portion of the delivery address information for the parcel and a value corresponding to the reference indicium;
forwarding the entry to a second database, different from the first database, the second database corresponding to the delivery address information;
reading the machine readable indicia during a second sortation pass, subsequent to the first, identifying the reference indicium and retrieving the entry corresponding to the reference indicium from the second database; and
sorting the parcel according to the portion of the delivery address information in the entry retrieved from the second database.

2. The method of claim 1, wherein the reference indicia includes a single machine readable indicium.

3. The method of claim 2, wherein the step of selecting a reference indicia further comprises determining if any single machine readable indicia applied to the parcel is unique in the database and selecting a unique machine readable indicium, if present, as the reference indicia.

4. The method of claim 2, wherein selecting the reference indicia includes selecting a single machine readable indicium that is not unique in the database.

5. The method of claim 1, further comprising resolving an ambiguity of non-unique reference indicia by sending a pick list including ambiguous database entries from the second database corresponding to the non-unique reference indicia to a video coding operator for selection.

6. A computer system for sorting parcels, the computer system comprising:
a processor, and
a memory including software instructions that, when executed, cause the computer system to perform the steps of:
reading, during a first sortation pass, at least one machine readable indicia and delivery address information on a parcel, the at least one machine readable indicia having been applied to the parcel prior to mailing;
selecting a reference indicium from the at least one machine readable indicia;
creating an entry, corresponding to the reference indicia, in a database, the entry including a portion of the delivery address information for the parcel and a value corresponding to the reference indicium;
reading the at least one machine readable indicia during a second sortation pass, subsequent to the first, identifying the reference indicium and retrieving the entry corresponding to the reference indicium from the database; and
sorting the parcel according to the portion of the delivery address information in the entry retrieved from the database.

7. The computer system of claim 6, wherein the reference indicia includes a single machine readable indicium.

8. The computer system of claim 6, wherein the reference indicia includes a combination of two or more discrete machine readable indicia.

9. The computer system of claim 6, wherein the step of selecting a reference indicia further comprises determining if any of the machine readable indicia applied to the parcel are unique in the database and selecting a unique machine readable indicia, if present, as the reference indicia.

10. The computer system of claim 6, wherein the step of selecting a reference indicia further comprises determining if any combination of the machine readable indicia applied to the parcel is unique in the database and selecting a unique machine readable indicia combination, if present, as the reference indicia.

11. The computer system of claim 6, wherein the step of selecting the reference indicia includes selecting a machine readable indicium that is not unique in the database.

12. The computer system of claim 11, further comprising resolving an ambiguity of non-unique reference indicia by sending a pick list including ambiguous database entries from the database corresponding to the non-unique reference indicia to a video coding operator for selection.

13. A computer program product for sorting parcels, the computer program product comprising:
software instructions for enabling a computer to perform predetermined operations; and
a computer readable medium bearing the software instructions;
the predetermined operations including the steps of:
reading, during a first sortation pass, machine readable indicia and delivery address information on a parcel, the machine readable indicia having been applied to the parcel prior to mailing for another purpose, the machine readable indicia including a non-unique machine readable indicium;
selecting a reference indicium from the machine readable indicia;
creating an entry, corresponding to the reference indicia, in a database, the entry including a portion of the delivery address information for the parcel and a value corresponding to the reference indicium;
reading the machine readable indicia during a second sortation pass, subsequent to the first, identifying the reference indicium and retrieving the entry corresponding to the reference indicium from the database; and
sorting the parcel according to the portion of the delivery address information in the entry retrieved from the database.

14. The computer program product of claim 13, wherein the reference indicia includes a single machine readable indicium.

15. The computer program product of claim 13, wherein the reference indicia includes a combination of two or more discrete machine readable indicia.

16. The computer program product of claim 13, wherein the step of selecting a reference indicia further comprises determining if any of the machine readable indicia applied to the parcel are unique in the database and selecting a unique machine readable indicia, if present, as the reference indicia.

17. The computer program product of claim 13, wherein the step of selecting a reference indicia further comprises determining if any combination of the machine readable indicia applied to the parcel is unique in the database and selecting a unique machine readable indicia combination, if present, as the reference indicia.

18. The computer program product of claim 13, further comprising resolving an ambiguity of any non-unique database entries retrieved using the reference indicia by sending a pick list including ambiguous database entries from the database corresponding to the non-unique reference indicia to a video coding operator for selection.
